(19) United States
(12) Patent Application Publication
(10) Pub. No.: US 2002/0074196 A1
(43) Pub. Date: Jun. 20, 2002

(54) Automobile brake device

(76) Inventor: Il-Rae Park, Ulsan (KR)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/012,343

(22) Filed: Dec. 12, 2001

(30) Foreign Application Priority Data
Dec. 14, 2000 (KR) 2000-76560

(51) Int. Cl. F16F 9/53

(52) U.S. Cl. 188/267.2; 188/267.1

(57) ABSTRACT

An automobile brake device, the device comprising: a brake disc; a brake pedal; a magnetic force generating unit for generating a magnetic force corresponding to amount of manipulation at the brake pedal; and magneto-rheological fluid where intrinsic viscosity of the fluid is changed by the magnetic force to generate shearing force and to apply braking force to the brake disc, such that manipulating power of brake pedal by a driver is immediately transmitted to wheels in response to electric signal, using MR fluid, to enable to embody a rapid response speed while dispensing with hydraulic oil to make brake booster, hydraulic pipe route and cylinder of caliper unnecessary thereto, thereby realizing swift generation of braking power with only simple combination of parts, whereby there is no fear raised about generation of vapor lock phenomenon at hydraulic brake device, and because of no brake pad used, there is no fear either about environmental pollution resulted from fade phenomenon or dust.

### BACKGROUND OF THE INVENTION

1. Field of the Inventio

The present invention relates to an automobile brake device, and more particularly to an automobile brake device adapted to utilize Magneto-Rheological Fluid: MR Fluid) for facilitating a smooth operation of brake.

2. Description of the Prior Art

Generally, automobile brake serves to reduce speed of an automobile or stably maintain a stopped state thereof, and is frequently manipulated by a driver while the automobile is running by way of pedal for adjusting an automobile speed or keeping a temporary stopped state.

By way of example, a hydraulic brake is taken up for perusal in general structure thereof. The brake includes a brake pedal for receiving brake manipulation from a driver, a master cylinder operated by a brake booster for amplifying manipulating power of brake pedal to generate a high degree of brake oil pressure, and a caliper for holding brake discs of wheels by way of oil pressure supplied from the master cylinder to generate a braking power.

Now, mechanism for generating the braking power to the brake disc of wheel will be described with reference to FIG. 1.

Brake disk 102 integrally connected to wheels 100 is constructed to allow brake pad 108 to abet on both sides thereof by caliper 106 secured at knuckle 104, and the brake pad 108 is made to change an adhered state with the brake disc 102 in response to movement of piston 112 operated in a cylinder 110 provided at the caliper 106, such that pressure applied to the brake disc 102 by the brake pad 108 is made to vary according to oil pressure provided to the cylinder 110 of the caliper 106, thereby enabling to obtain a desired brake power.

However, there are problems in the brake device thus constructed according to the prior art in that brake manipulation of a driver is changed by hydraulic oil and again piston 112 of caliper 106 is mechanically moved to obtain the braking power such that many parts are needed for generation of hydraulic pressure and supply, resulting in trouble of obtaining installation space of the parts, while dust particles generated by friction between the brake pad 108 and the brake disc 102 become the reason of environmental contamination, and a separate structure is needed to easily emit the heat generated therefrom, and a relatively long period of time is consumed for manipulating force of the driver to reach the wheels 100.

### SUMMARY OF THE INVENTION

The present invention is disclosed to solve the aforementioned problems and it is an object of the present invention to provide an automobile brake device adapted to use magneto-rheological fluid (MR Fluid) to prompt manipulating force of brake by a driver to be swiftly transmitted to wheels in response to electrical signal, thereby embodying a rapid response speed while oil pressure is not used to allow simple construction of parts to perform a smooth braking function.

In accordance with the object of the present invention, there is provided an automobile brake device, the device comprising:

a brake disc;

a brake pedal;

magnetic force generating means for generating a magnetic force corresponding to amount of manipulation at the brake pedal; and

magneto-rheological fluid where intrinsic viscosity of the fluid is changed by the magnetic force to generate shearing force and to apply braking force to the brake disc.

### BRIEF DESCRIPTION OF THE DRAWINGS

For fuller understanding of the nature and objects of the invention, reference should be made to the following detailed description taken in conjunction with the accompanying drawings in which:

FIG. 1 is a structural drawing for illustrating an automobile brake device according to the prior art;

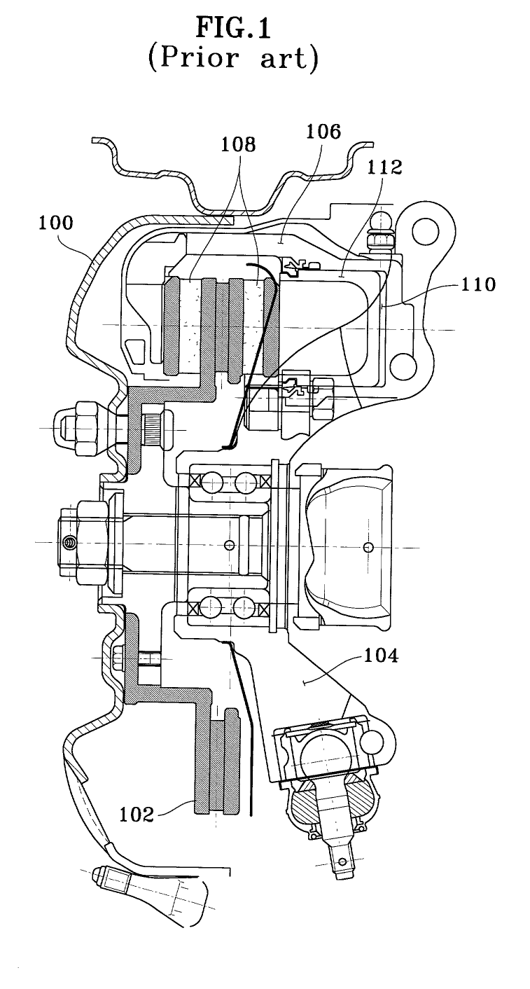

FIG. 2 is a structural drawing for illustrating an automobile brake device according to the present invention; and

FIG. 3 is a detailed enlarged drawing for illustrating a housing part of FIG. 2.

### DETAILED DESCRIPTION OF THE INVENTION

Now, preferred embodiment of the present invention will be described in detail with reference to the accompanying drawings.

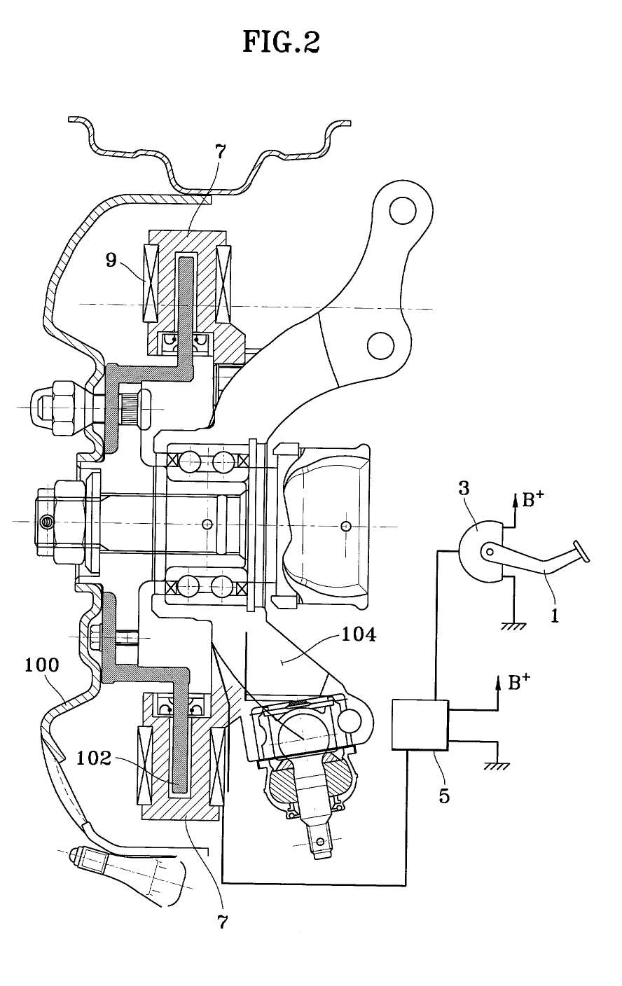

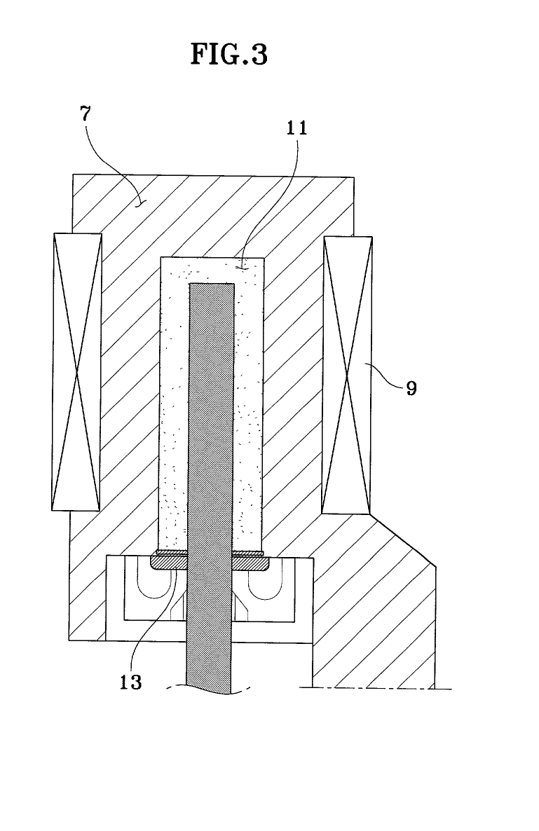

Throughout the drawings in FIGS. 2 and 3, like or equivalent reference numerals names are used for designation of like or equivalent parts or portions for simplicity of illustration and explanation.

FIG. 2 is a structural drawing for illustrating an embodiment of automobile brake device according to the present invention, where a brake pedal 1 for receiving brake manipulation of a driver is mounted with a stepping force detecting sensor 3 for detecting a manipulated state of the brake pedal 1 so that the manipulated state of a driver is changed to an electrical signal, where the signal is received by a controller 5.

Meanwhile, a wheel 100 is provided with a housing 7 encompassing an entire circumference of a brake disc 102 integrally fixed to the wheel 100 and secured to a knuckle 104, and wound by coil 9 to thereby be controlled by the controller 5.

Magneto-rheological Fluid (MR fluid) 11 is filled in a space between interior of the housing 7 and the brake disc 102.

The coil 9 is so wound as to allow magnetic line of force generated therefrom to maximally pass through the MR fluid 11 because the coil 9 generates the magnetic line of force to supply same to the MR fluid 11 filled in the space between the interior of the housing 7 and the brake disc 102. Of course, sealing 13 is mounted at an inner wall of the housing 7 to prevent the MR fluid 11 filled in the space between the interior of the housing 7 and the brake disc 102 from being leaked.

At this location, the MR fluid 11 is non-colloid solution where nonconductive solution such as silicon oil or mineral oil is dispersed therein with particles having micron-sized magnetic force, and is also fluid where mechanical characteristic thereof is changed by magnetic field load, and is basically solution where solvent having a lower permeability is dispersed with paramagnetic particles.

The MR fluid 11 is a fluid which carries a property of Newtonian fluid having a random structure under no load where magnetic field is not loaded but once the magnetic field is loaded, dispersed particles having magneticism become polarized to form a chain-like fibrous tissue to a direction parallel with the loaded magnetic field and to be changed to Bingham fluid having a predetermined yield shear stress even without shear strain forces such as shearing force and resistant force.

Furthermore, the MR fluid 11 is a fluid that shows an isotropic characteristic when there is no load at the electric field by way of free movement at the dispersed particles while in fluid state, however when the electric field is applied by electro sensitive fluid, particles dispersed in the fluid give rise to induced polarization to form a plurality of fibrous tissue, thereby possessing anisotropic behavior, such that the MR fluid 11 keeps an advantage of rapid response speed possessed by Electro-rheological fluid which is a kind of controllable fluid having a characteristic of showing resistance to flow of fluid or force against load applied from outside, while coping with disadvantage of low yield sharing force, narrow temperature scope of use, sensitivity to impurities and the like.

The present invention is disclosed to utilize the characteristics of MR fluid thus described where a preferred embodiment of the present invention is now described at operation thereof.

When a driver steps on the brake pedal 1 to exercise an braking operation while an automobile is running, degree of being stepped on at the brake pedal 1 is detected by the stepping force detecting sensor 3 to be supplied to the controller 5, where the controller 5 discriminates a brake manipulation states of the driver in response to a signal detected therefrom and provides current to the coil 9 mounted on the housing 7 according to the degree of brake manipulation.

As a result, the coil 9 generates magnetic force in response to supplied amount of current to supply same to the MD fluid 11 filled in the housing 7, such that the MD fluid 11 is changed in its viscosity to be switched to a state of generating a shearing force, where the brake disc 102 is restricted in rotation thereof to thereby obtain braking power.

Of course, the size of braking power thus described reflects the manipulation state of brake pedal 1 by the driver as it is, whereby the controller 5 adjusts the amount of current provided to the coil 9 such that magnetic force generated from the coil 9 is changed, which again gives rise to change of shearing force at the MR fluid 11 and is manifested in terms of force for directly restricting rotary movement of the brake disc 102, thereby prompting an extremely easy control thereof.

Meanwhile, the brake pedal 1 is not manipulated in a normal running state where braking power thus described is not necessary, so that the controller 5 does not provide current to the coil 9 whereby the MR fluid 11 helps the brake disc 102 rotate smoothly just like lubricant, thereby enabling an automobile to run at a normal state.

The present invention thus disclosed may be applied to ABS device, where, the controller 5 utilizes a separately-mounted speed sensor to calculate wheel speed and slip rate and to properly adjust amount of current supplied to the coil 9 according to time lapse, whereby wheel slip is actively controlled to be able to simply embody an operation of ABS.

As apparent from the foregoing, there is an advantage in the automobile brake device thus described according to the present invention in that manipulating power of brake pedal 1 by a driver is immediately transmitted to wheels 100 in response to electric signal, utilizing MR fluid 11, to enable to embody a rapid response speed while dispensing with hydraulic oil to make brake booster, hydraulic pipe route and cylinder of caliper unnecessary thereto, thereby realizing swift generation of braking power with only simple combination of parts.

There is another advantage in that there is no fear raised about generation of vapor lock phenomenon at hydraulic brake device, and because of no brake pad used, there is no fear either about environmental pollution resulted from fade phenomenon or dust.

What is claimed is:

1. An automobile brake device, the device comprising:
a brake disc;
a brake pedal;
magnetic force generating means for generating a magnetic force corresponding to amount of manipulation at the brake pedal; and
magneto-rheological fluid where intrinsic viscosity of the fluid is changed by the magnetic force to generate shearing force and to apply braking force to the brake disc.

2. The device as defined in claim 1 further comprising:
a stepping force detecting sensor for detecting amount of manipulation of the brake pedal; and
a controller for receiving a signal detected from the stepping force detecting sensor to apply a control current corresponding to the amount of manipulation to the magnetic force generating means.

3. The device as defined in claim 2, wherein a wheel provided with a housing encompassing an entire circumference of the brake disc integrally fixed to the wheel and secured to a knuckle, where Magneto-rheological fluid is filled in a space between interior of the housing and the brake disc.

4. The device as defined in claim 3, wherein the magnetic force generating means is a coil wound outside of the housing.
